(19) United States
(12) Patent Application Publication
(10) Pub. No.: US 2024/0019576 A1
(43) Pub. Date: Jan. 18, 2024

(54) RANGING DEVICE

(71) Applicant: CANON KABUSHIKI KAISHA, Tokyo (JP)

(72) Inventor: MASASHI NIWA, Chiba (JP)

(21) Appl. No.: 18/348,075

(22) Filed: Jul. 6, 2023

(30) Foreign Application Priority Data
Jul. 13, 2022 (JP) 2022-112271

(51) Int. Cl. G01S 17/10; G01S 7/4865; G01S 17/931

(52) U.S. Cl. CPC G01S 17/10; G01S 7/4865; G01S 17/931

(57) ABSTRACT

A ranging device selectively generates, for each frame period, either a first frequency distribution generated at a first time interval or a second frequency distribution generated at a second time interval shorter than the first time interval, determines a second parameter used for acquiring the second frequency distribution based on first time information indicating a time corresponding to a peak of the number of pulses in the first frequency distribution, and determines a first parameter used for acquiring the first frequency distribution based on second time information indicating a time corresponding to a peak of the number of pulses in the second frequency distribution.

### BACKGROUND OF THE INVENTION

### Field of the Invention

The present disclosure relates to a ranging device.

### Description of the Related Art

Japanese Patent Application Laid-Open No. 2021-001763 discloses a ranging device that measures a distance to an object based on a time difference between a time at which light is irradiated and a time at which reflected light is received. The ranging device of Japanese Patent Application Laid-Open No. 2021-001763 calculates a distance from a frequency distribution of a count value of incident light with respect to time from light emission. In Japanese Patent Application Laid-Open No. 2021-001763, a first frequency distribution (histogram) is generated based on a count value counted at a first temporal resolution. Then, in a bin range determined from the first frequency distribution, a second frequency distribution is generated based on a count value counted at a second temporal resolution, and a distance is calculated from the second frequency distribution. At this case, by setting the second temporal resolution higher than the first temporal resolution, the circuit area for storing the frequency distribution can be reduced.

However, in the case where the storage capacity is reduced by a method using a plurality of frequency distributions with different temporal resolutions as in Japanese Patent Application Laid-Open No. 2021-001763, the accuracy of ranging may be reduced.

### SUMMARY OF THE INVENTION

It is an object of the present disclosure to provide a ranging device capable of achieving both reduction of storage capacity and high ranging accuracy.

According to a disclosure of the present specification, there is provided a ranging device including: a time counting unit configured to perform time counting; a pulse generation unit configured to generate a signal including a pulse based on light including reflected light from an object; a frequency distribution storage unit configured to store a frequency distribution including first information on time and second information on the number of pulses; a peak detection unit configured to determine time information indicating a time corresponding to a peak of the number of pulses based on the frequency distribution; a parameter determination unit configured to determine, based on the time information, a parameter used for acquiring a frequency distribution in a frame period next to a frame period in which the time information is acquired; and a decoder unit configured to change the second information of the frequency distribution stored in the frequency distribution storage unit. In accordance with the parameter, the time counting unit or the decoder unit is configured to change the first information of the frequency distribution. The decoder unit selectively generates, for each frame period, either a first frequency distribution generated at a first time interval or a second frequency distribution generated at a second time interval shorter than the first time interval. The parameter determination unit determines a second parameter used for acquiring the second frequency distribution based on first time information indicating a time corresponding to a peak of the number of pulses in the first frequency distribution. The parameter determination unit determines a first parameter used for acquiring the first frequency distribution based on second time information indicating a time corresponding to a peak of the number of pulses in the second frequency distribution.

According to a disclosure of the present specification, there is provided a ranging device including: a time counting unit configured to perform time counting; a pulse generation unit configured to generate a signal including a pulse based on light including reflected light from an object; a frequency distribution storage unit configured to store a frequency distribution including first information on time and second information on the number of pulses; a peak detection unit configured to determine time information indicating a time corresponding to a peak of the number of pulses based on the frequency distribution; a parameter determination unit configured to determine, based on the time information, a parameter used for acquiring a frequency distribution in a frame period next to a frame period in which the time information is acquired; and a decoder unit configured to change the second information of the frequency distribution stored in the frequency distribution storage unit. In accordance with the parameter, the time counting unit or the decoder unit is configured to change the first information of the frequency distribution. The decoder unit selectively generates, for each frame period, any one of three or more frequency distributions having different time intervals. The parameter determination unit determines a parameter used for acquiring a frequency distribution generated at the longest time interval among the three or more frequency distributions based on time information indicating a time corresponding to a peak of the number of pulses in a frequency distribution generated at the shortest time interval among the three or more frequency distributions.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration example of a ranging device according to a first embodiment.

FIG. 2 is a diagram schematically illustrating an operation of the ranging device according to the first embodiment in one ranging period.

FIGS. 3A, 3B, 3C, and 3D are histograms schematically illustrating frequency distributions of pulse count values according to the first embodiment.

FIGS. 4A, 4B, and 4C are histograms for explaining examples of resolution switching according to the first embodiment.

FIG. 5 is a schematic diagram illustrating an example of resolution switching according to the first embodiment.

FIGS. 6A, 6B, and 6C are histograms for explaining an example in which errors occur in switching resolution.

FIGS. 7A, 7B, and 7C are histograms for explaining an example of switching of the acquisition start time of the frequency distribution according to the first embodiment.

FIG. 8 is a flowchart illustrating an operation of the ranging device according to the first embodiment.

FIGS. 9A and 9B are timing charts illustrating the operation of the decoder unit according to the first embodiment.

FIG. 10 is a block diagram illustrating a schematic configuration example of a ranging device according to a second embodiment.

FIGS. 11A, 11B, and 11C are histograms for explaining an example of changing a length of a time interval of a frequency distribution according to the second embodiment.

FIG. 12 is a histogram for explaining a bin determination method for changing the length of the time interval according to the second embodiment.

FIG. 13 is a schematic view illustrating an overall configuration of a photoelectric conversion device according to a third embodiment.

FIG. 14 is a schematic block diagram illustrating a configuration example of a sensor substrate according to the third embodiment.

FIG. 15 is a schematic block diagram illustrating a configuration example of a circuit substrate according to the third embodiment.

FIG. 16 is a schematic block diagram illustrating a configuration example of one pixel of a photoelectric conversion unit and a pixel signal processing unit according to the third embodiment.

FIGS. 17A, 17B, and 17C are diagrams illustrating an operation of the avalanche photodiode according to the third embodiment.

FIG. 18 is a schematic diagram of a photodetection system according to a fourth embodiment.

FIGS. 19A and 19B are schematic diagrams of equipment according to a fifth embodiment.

### DESCRIPTION OF THE EMBODIMENTS

Preferred embodiments of the present invention will now be described in detail in accordance with the accompanying drawings. In the drawings, the same or corresponding elements are denoted by the same reference numerals, and the description thereof may be omitted or simplified.

### First Embodiment

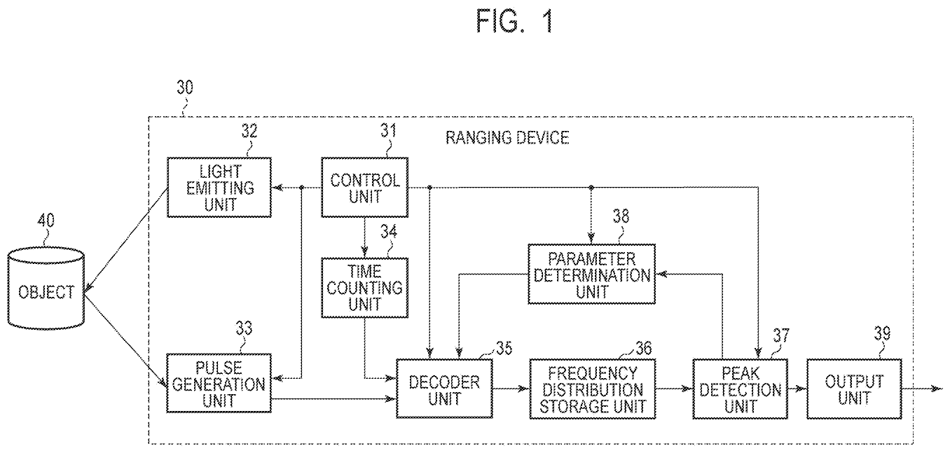

FIG. 1 is a block diagram illustrating a schematic configuration example of a ranging device 30 according to the present embodiment. The ranging device 30 includes a control unit 31, a light emitting unit 32, a pulse generation unit 33, a time counting unit 34, a decoder unit 35, a frequency distribution storage unit 36, a peak detection unit 37, a parameter determination unit 38, and an output unit 39. Note that the configuration of the ranging device 30 illustrated in the present embodiment is an example, and is not limited to the illustrated configuration.

The ranging device 30 measures a distance to an object 40 by using a technique such as a light detection and ranging (LiDAR). The ranging device 30 measures a distance from the ranging device 30 to the object 40 based on a time difference until light emitted from the light emitting unit 32 is reflected by the object 40 and received by the pulse generation unit 33.

The light received by the pulse generation unit 33 includes ambient light such as sunlight in addition to the reflected light from the object 40. For this reason, the ranging device 30 measures incident light at each of a plurality of time intervals, and performs ranging in which the influence of ambient light is reduced by using a method of determining that reflected light is incident during a period in which the amount of light peaks. The ranging device 30 of the present embodiment may be, for example, a flash LiDAR that emits laser light to a predetermined ranging area including the object 40, and receives reflected light by a pixel array.

The control unit 31 is a control circuit that outputs a control signal indicating an operation timing, an operation condition, and the like of each unit of the ranging device 30 to the light emitting unit 32, the pulse generation unit 33, the time counting unit 34, the decoder unit 35, the peak detection unit 37, and the parameter determination unit 38. Thus, the control unit 31 controls these units.

The light emitting unit 32 is a light source that emits light such as laser light to the outside of the ranging device 30. When the ranging device 30 is a flash LiDAR, the light emitting unit 32 may be a surface light source such as a surface emitting laser.

The pulse generation unit 33 generates a pulse signal including a pulse based on incident light. The pulse generation unit 33 is, for example, a photoelectric conversion device including an avalanche photodiode as a photoelectric conversion element. In this case, when one photon is incident on the avalanche photodiode and a charge is generated, one pulse is generated by avalanche multiplication. However, the pulse generation unit 33 may use, for example, a photoelectric conversion element using another photodiode.

The time counting unit 34, the decoder unit 35, the frequency distribution storage unit 36, the peak detection unit 37, the parameter determination unit 38, and the output unit 39 are signal processing circuits that perform signal processing on the pulse signal output from the pulse generation unit 33. The signal processing circuit may include a counter for counting pulses, a processor for performing arithmetic processing of digital signals, a memory for storing digital signals, and the like. The memory may be, for example, a semiconductor memory. The control unit 31 controls the operation timing and the like of each unit in the signal processing circuit.

The time counting unit 34 performs time counting based on the control of the control unit 31, and acquires an elapsed time from a time at which counting is started as a digital signal. The control unit 31 synchronously controls a timing at which the light emitting unit 32 emits light and a timing at which the time counting unit 34 starts time counting. Thus, the time counting unit 34 can count an elapsed time from the light emission in the light emitting unit 32. The time counting unit 34 includes, for example, a circuit such as a ring oscillator and a counter, and counts a clock pulse that vibrates at high speed and at a constant period, thereby performing time counting.

The control unit 31 controls the light emission and the start of time counting a plurality of times within one frame period. In addition, the control unit 31 outputs, to the decoder unit 35, the peak detection unit 37, and the parameter determination unit 38, a control signal for notifying a timing at which the processing is started and a control signal for switching a temporal resolution in acquiring the frequency distribution for each frame period. The switching of the temporal resolution will be described in detail later. The switching of the temporal resolution in the acquisition of the frequency distribution may be based on a control signal input from the outside of the ranging device 30, or may be based on register settings. Further, each unit of the ranging device may be configured to automatically switch the temporal resolution for each frame period.

The light emitted from the light emitting unit 32 is reflected by the object 40. The light including the reflected light from the object 40 is incident on the pulse generation unit 33. The pulse generation unit 33 converts the light into a pulse signal and outputs the pulse signal to the decoder unit 35.

The decoder unit 35 performs memory control to update the value of the corresponding memory address of the frequency distribution storage unit 36 based on the pulse signal output from the pulse generation unit 33 and a time count value at a timing at which the pulse is emitted.

The frequency distribution storage unit 36 is a memory that stores the number of input pulses, that is, the number of photons detected by the pulse generation unit 33 (pulse count value) for each set time interval. Since each of the plurality of time intervals corresponds to one interval of the histogram of the number of photons, it may be referred to as a bin.

The peak detection unit 37 calculates peak time information indicating a time at which the pulse count value is a peak from the data of the frequency distribution stored in the frequency distribution storage unit 36. The parameter determination unit 38 determines the acquisition start time and the acquisition end time of the frequency distribution in the next frame period based on the peak time information calculated by the peak detection unit 37, and outputs a control signal indicating these times to the decoder unit 35.

The output unit 39 acquires the peak time information from the peak detection unit 37 and outputs the information to an external device of the ranging device 30. The output unit 39 may output peak time information corresponding to one peak as a ranging result, or may output peak time information corresponding to a plurality of peaks as a ranging result. The output unit 39 may output distance information calculated from the peak time information and the light speed.

When the ranging device 30 is a flash LiDAR, although not illustrated in FIG. 1, the pulse generation unit 33 may be arranged as a pixel array forming a plurality of rows and a plurality of columns. In this case, a plurality of sets of the decoder unit 35, the frequency distribution storage unit 36, the peak detection unit 37, and the parameter determination unit 38 are arranged so as to correspond to the plurality of pulse generation units 33, respectively.

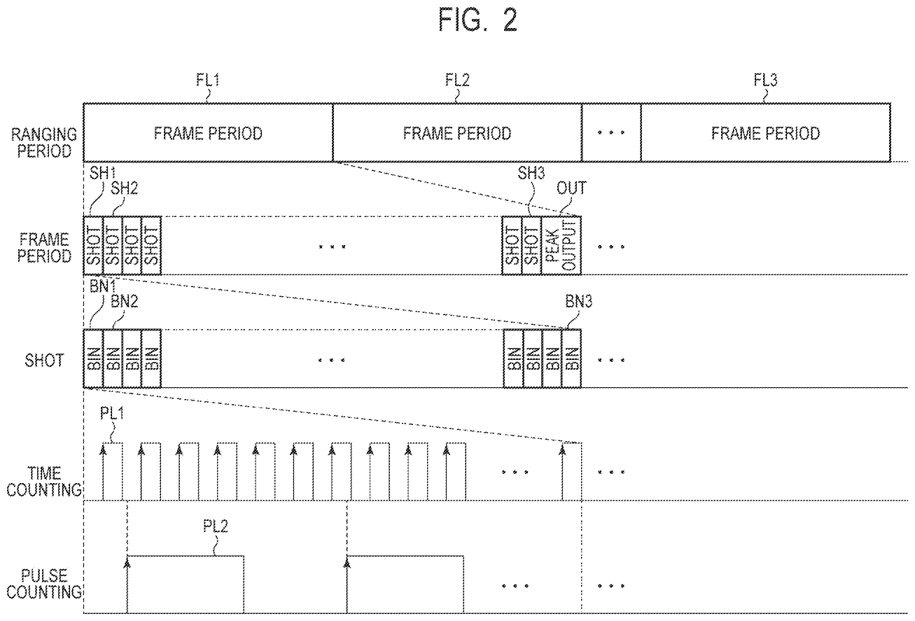

FIG. 2 is a diagram illustrating an outline of the operation of the ranging device 30 according to the present embodiment in one ranging period. In the description of FIG. 2, it is assumed that the ranging device 30 is a flash LiDAR. In the “ranging period” of FIG. 2, a plurality of frame periods FL1, FL2, . . . FL3 included in one ranging period are illustrated. The frame period FL1 indicates a first frame period in one ranging period, the frame period FL2 indicates a second frame period in one ranging period, and the frame period FL3 indicates a last frame period in one ranging period. The frame period is a period in which the ranging device 30 performs one ranging and outputs one signal indicating a distance (ranging result) from the ranging device 30 to the object 40 to the outside.

In the “frame period” of FIG. 2, a plurality of shots SH1, SH2, . . . , SH3 included in the frame period FL1 and a peak output OUT are illustrated. The shot is a period in which the light emitting unit 32 emits light once and the frequency distribution stored in the frequency distribution storage unit 36 is updated by a pulse count value based on the light emission. The shot SH1 indicates a first shot in the frame period FL1. The shot SH2 indicates a second shot in the frame period FL1. The shot SH3 indicates a last shot in the frame period FL1. The peak output OUT indicates a period during which a ranging result is output based on a peak acquired by accumulating signals of a plurality of shots.

In the “shot” of FIG. 2, a plurality of bins BN1, BN2, . . . , BN3 included in the shot SH1 are illustrated. The “bin” indicates one time interval during which a series of pulse counting is performed, and is a period during which the decoder unit 35 performs pulse counting to acquire a pulse count value. The bin BN1 indicates a first bin in the shot SH1. The bin BN2 indicates a second bin in the shot SH1. The bin BN3 indicates a last bin in the shot SH1.

The “time counting” in FIG. 2 schematically illustrates a pulse PL1 used for time counting in the time counting unit 34 in the bin BN1. As illustrated in FIG. 2, the time counting unit 34 generates a time count value by counting the pulse PL1 that rises periodically. When the time count value reaches a predetermined value, the bin BN1 ends, and the process transitions to the next bin BN2.

The “pulse counting” in FIG. 2 schematically illustrates pulses based on incident light output from the pulse generation unit 33 in the bin BN1 and counted in the decoder unit 35. When one photon is incident on the pulse generation unit 33, one pulse PL2 rises. In the example of FIG. 2, two pulses rise in the period of the bin BN1, and “2” is acquired as the pulse count value of the bin BN1. Similarly, pulse count values are sequentially acquired in the same manner after the bin BN2. As illustrated in FIG. 2, the frequency of the pulse PL1 of the time counting is set sufficiently higher than the frequency of the rising edge of the pulse PL2 of the pulse counting. In this case, the number of pulses PL2 can be appropriately counted.

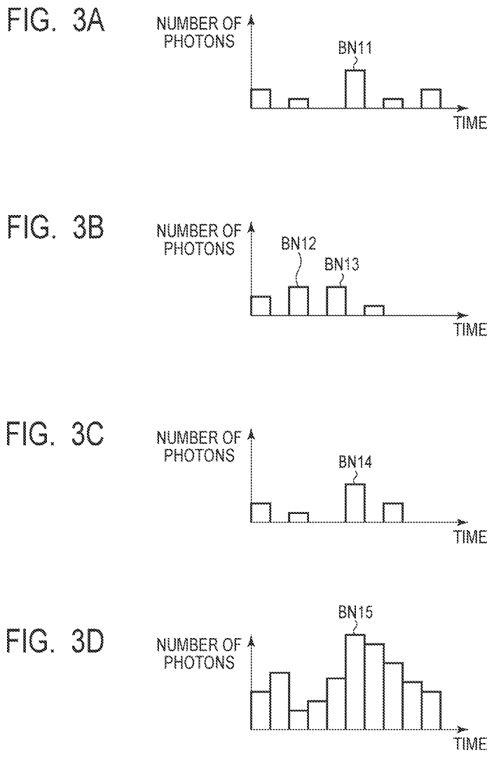

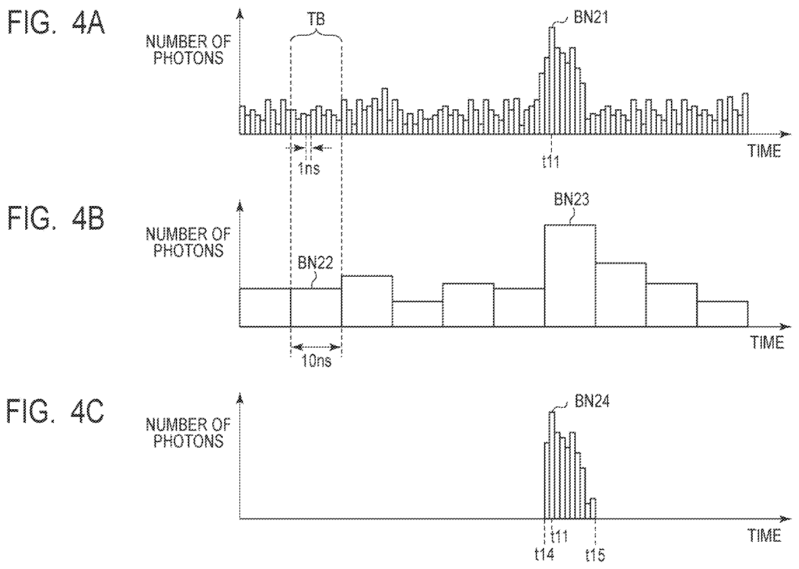

FIGS. 3A to 3D are histograms visually illustrating frequency distributions of pulse count values counted by the decoder unit 35. In this specification, the frequency distribution is frequency information corresponding to a predetermined class width, and is not necessarily displayed visually. FIGS. 3A, 3B, and 3C illustrate examples of histograms of the numbers of photons (corresponding to pulse count values) in the first shot, the second shot, and the third shot, respectively. FIG. 3D illustrates an example of a histogram acquired by integrating the number of photons of all shots. The horizontal axis represents the elapsed time from light emission. An interval of the histogram corresponds to a period of one bin in which photon detection is performed. The vertical axis represents the number of photons detected in each bin period. Thus, the histogram includes first information (horizontal axis) on time and second information (vertical axis) on the number of pulses. Specifically, the first information includes, for example, the start time and the end time of the time interval of the bin, the width (resolution) of the time interval of the bin, and the like. On the other hand, the second information is, for example, the number of pulses detected within the time interval of each bin. Similarly, the frequency distribution also includes first information on time and second information on the number of pulses.

As illustrated in FIG. 3A, in the first shot, the number of photons of the sixth bin BN11 is a peak. As illustrated in FIG. 3B, in the second shot, the number of photons of the third bin BN12 is equal to the number of photons of the fifth bin BN13, and these are peaks. As illustrated in FIG. 3C, in the third shot, the number of photons of the sixth bin BN14 is a peak. In the second shot, different bins from the other shots are peaks. This is due to pulse count values due to ambient light other than reflected light from the object 40.

As illustrated in FIG. 3D, in the histogram obtained by integrating the number of photons of all shots, the sixth bin BN15 is a peak. In the peak output OUT illustrated in FIG. 2, time information of the bin corresponding to the peak of the integrated frequency distribution is output. The distance between the ranging device 30 and the object 40 can be calculated from the time information.

By integrating the pulse count values of a plurality of shots, it is possible to detect a bin having a high possibility of reflected light from the object 40 more accurately even when pulse count by ambient light is included as in the second shot illustrated in FIG. 3B. Therefore, even when the light emitted from the light emitting unit 32 is weak, the ranging can be performed with high accuracy by employing a process in which a plurality of shots are repeated.

The ranging device 30 of the present embodiment performs a process of switching the temporal resolution by changing the time interval of the bins and a process of determining the acquisition start time of the frequency distribution from the peak time information on a frame-by-frame basis. The outline of these processes will be described below.

FIGS. 4A to 4C are histograms for explaining examples of resolution switching according to the present embodiment. FIG. 4A illustrates an example of a histogram in a case where bins with short time intervals, that is, bins with high resolution, are set in all time ranges corresponding to a distance range in which ranging is possible. FIG. 4A is not a histogram of the frequency distribution generated in the present embodiment, but is illustrated as a comparative example for explanation. When the resolution of the bin is increased, the detection time interval of the reflected light becomes finer, so that the distance resolution in the ranging is improved. In the example of FIG. 4A, the time interval of one bin is set to 1 ns, and the distance resolution is 15 cm. Since the number of bins is 100, the distance at which the distance can be measured is 15 m at the maximum. For example, when the number of shots in one frame period is 1000, a storage capacity of 10 bits is required for one bin. Therefore, in the case where the light receiving element of the ranging device 30 has a large number of pixels and ranging can be performed far from the ranging device 30, a large amount of storage capacity is required, and the storage capacity may not fall within a practical amount of storage capacity. In the example of FIG. 4A, the bin BN21 at time t11 is a peak.

FIG. 4B is an example of resolution setting in the present embodiment, and is an example of a histogram in a case where low resolution bins are set. In the example of FIG. 4B, the time interval of one bin is set to 10 ns, and the number of bins is 10. The sum of the photon numbers of the ten bins included in the period TB of FIG. 4A corresponds to the photon number of one bin BN22 of the period TB of FIG. 4B. Note that the configuration of the bin which can be applied in the present embodiment is not limited to the exemplified configurations and the examples described later. The configuration of the bin can be determined by comprehensively considering the maximum ranging distance, the required distance resolution, the circuit scale of the ranging device 30, and the like.

FIG. 4C is an example of resolution setting in the present embodiment, and is an example of a histogram in a case where high resolution bins are set. In the example of FIG. 4C, the time interval of one bin is set to 1 ns as in the example of FIG. 4A. The number of bins is 10. In the example of FIG. 4C, the peak bin BN23 is extracted from the frequency distribution acquired in the low resolution bin setting of FIG. 4B. Then, the frequency distribution is acquired with the high resolution bin setting within a time interval corresponding to the BN23. In FIG. 4C, time t14 is the acquisition start time of the frequency distribution, and time t15 is the acquisition end time of the frequency distribution. These times are set so as to coincide with the period of the peak bin BN23. By performing the setting as illustrated in FIG. 4C, the bin BN24 at the time t11 can be detected as a peak as in the case of FIG. 4A. Further, the number of bins can be reduced as compared with the example of FIG. 4A, and the necessary storage capacity is reduced.

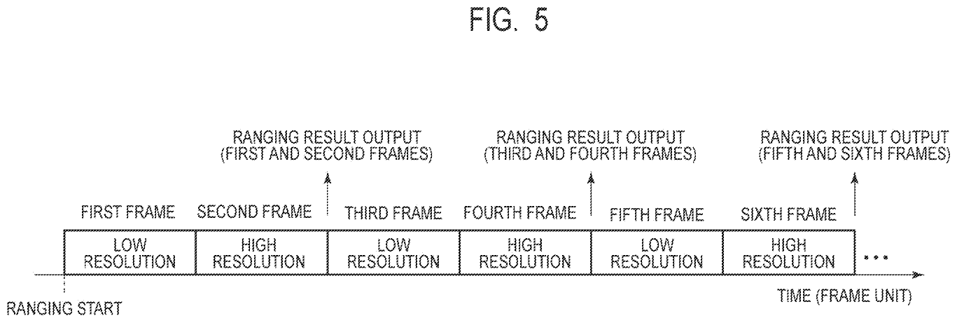

Although the low resolution bin setting in FIG. 4B and the high resolution bin setting in FIG. 4C can be selectively set, the process of switching the setting is performed on a frame-by-frame basis. FIG. 5 is a schematic diagram illustrating an example of switching resolution according to the present embodiment. FIG. 5 illustrates an example in which resolution setting is alternately switched for each frame. As illustrated in FIG. 5, in the first frame immediately after the start of ranging, the frequency distribution is acquired with the low resolution bin setting as illustrated in FIG. 4B. In the next second frame, the frequency distribution is acquired after switching to the high resolution bin setting as illustrated in FIG. 4C. After the processing for the first and second two frames, calculation and output of the distance, which is a ranging result, are performed. Similarly, the high resolution bin setting and the low resolution bin setting are alternately switched after the third frame, and the ranging result is output after the processing for two frames.

Although FIG. 5 illustrates an example in which two kinds of resolutions of the high resolution bin and the low resolution bin are alternately switched, the present embodiment is not limited thereto. For example, three or more kinds of resolutions may be switched. As an example, a case where three types of bins of the first resolution, the second resolution, and the third resolution can be set will be described. First, in the first frame, a frequency distribution is acquired with the first resolution bin setting. In the next second frame, a frequency distribution of bins in a range determined based on the frequency distribution acquired with the first resolution bins is acquired with the second resolution setting. In the next third frame, a frequency distribution is acquired with the third resolution setting for bins in a range determined based on the frequency distribution acquired with the second resolution bin setting. Then, in the next fourth frame, a frequency distribution is acquired with the first resolution setting for bins in a range determined based on the frequency distribution acquired with the third resolution bins. Similarly, the settings of three types of bins of the first resolution, the second resolution, and the third resolution are sequentially switched. From the viewpoint of reducing the number of bins in which the frequency distribution is acquired, it is desirable that the second resolution be higher than the first resolution and the third resolution be higher than the second resolution. For example, the time intervals of bins in the first resolution, the second resolution, and the third resolution may be set as 100 ns, 10 ns, and 1 ns, respectively. The method of switching three or more kinds of resolutions can be applied not only to the present embodiment but also to a second embodiment described later.

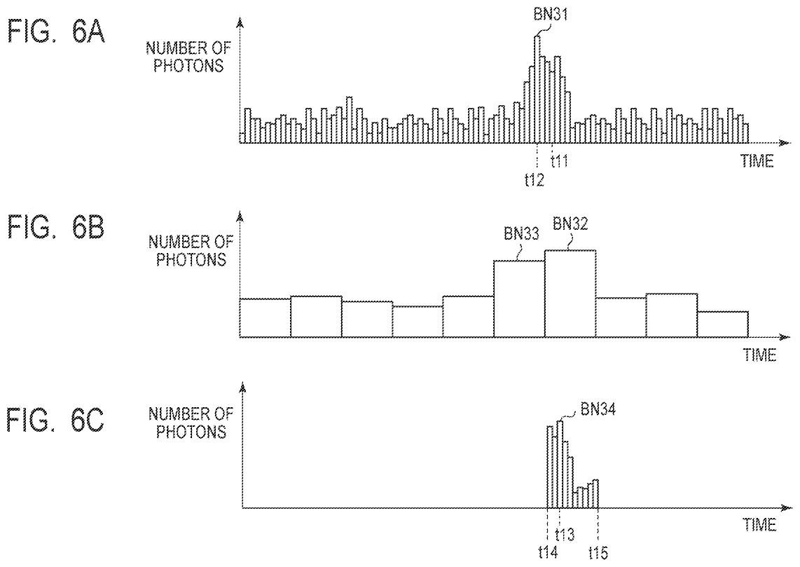

FIGS. 6A to 6C are histograms for explaining an example in which errors occur in switching resolution. FIGS. 6A to 6C illustrate comparative examples for explanation as in FIG. 4A. FIG. 6A illustrates an example of a histogram when high resolution bins are set in all time ranges. FIG. 6A illustrates a situation in which time of a peak bin BN31 is shifted from time t11 to time t12 in a frame different from that in FIG. 4A. This situation indicates that the distance between the object 40 and the ranging device 30 is close to that in the example of FIG. 4A. Such an event that the position of the peak varies between frames may occur, for example, when the object 40 is a movable body.

FIG. 6B illustrates an example of a histogram when the low resolution bins are set. FIG. 6B illustrates an example of a histogram acquired in the same setting as in FIG. 4B in the situation of FIG. 6A.

FIG. 6C illustrates an example of a histogram when the high resolution bins are set. In the example of FIG. 6C, a peak bin BN32 is extracted from the frequency distribution acquired in the low resolution bin setting of FIG. 6B. Then, a frequency distribution is acquired by setting the time interval corresponding to the BN32 to high resolution bins.

In FIG. 6A, the bin BN31 at the time t12 is a peak. On the other hand, in FIG. 6B, not a bin BN33 including the time t12 but the bin BN32 is a peak. Therefore, in FIG. 6C which is the frequency distribution acquired in the high resolution setting, a bin BN34 at time t13 is detected as a peak. Thus, in the example of FIG. 6C, the bin BN34 different from the originally expected bin BN31 is detected, and an error occurs. Since the light emitted from the light emitting unit 32 has a certain pulse width and the reflected light similarly has a pulse width, the peak of the histogram due to the reflected light also has a certain width as illustrated in FIG. 6A. Therefore, as illustrated in FIGS. 6A and 6B, when the reflected light is incident at a time near the boundary of a low resolution bin, an error may occur, and the ranging accuracy may be lowered.

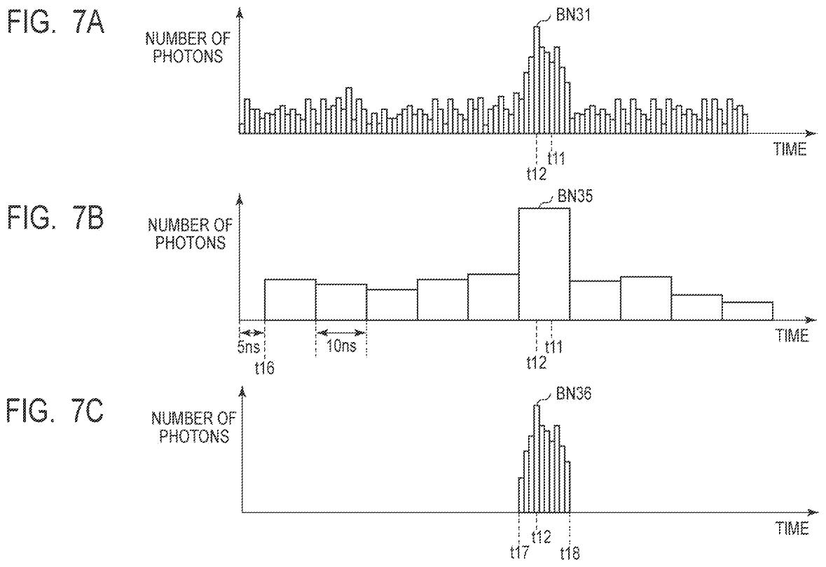

FIGS. 7A to 7C are histograms for explaining examples of switching of the acquisition start time of the frequency distribution according to the present embodiment. FIG. 7A is similar to FIG. 6A.

FIG. 7B illustrates an example of a histogram based on the low resolution bins when the acquisition start time of the frequency distribution is changed. FIG. 7C illustrates an example of a histogram based on the high resolution bins when the acquisition start time of the frequency distribution is changed. Further, as illustrated in FIG. 7B, in this example, since the acquisition start time of the frequency distribution is changed to time t16 delayed by 5 ns, all bins are delayed by 5 ns as compared with the example of FIG. 6B.

The acquisition start time of the frequency distribution is determined based on peak time information of the frequency distribution acquired with the high resolution bins of the previous frame. For example, when it is detected that the earliest or latest two bins (that is, bins in the vicinity of the boundary) are peaks among the ten high resolution bins acquired in the previous frame, the acquisition start time of the frequency distribution is delayed by ½ of the time interval of the low resolution bins. This allows peaks to be separated from the boundaries of time intervals of the low resolution bins. Assuming that FIG. 4C illustrates the processing result of the previous frame, since the time t11 of the bin BN24, which is the peak, is located near the boundary of the low resolution bin, the acquisition start time of the frequency distribution is delayed by a time that is ½ of the low resolution time interval (5 ns). As a result, the time of the peak of the previous frame at time t11 can be shifted from the vicinity of the boundary of the low resolution bin to the vicinity of the center of the bin, so that it is possible to prevent a decrease in accuracy when the distance between the object 40 and the ranging device 30 changes.

Specifically, as illustrated in FIG. 7B, a low resolution bin BN35 including the time t12 is a peak. As a result, as illustrated in FIG. 7C, a peak bin BN36 is detected at the time t12 in a period between time t17 and time t18 in which the frequency distribution with the high resolution bins is acquired. Therefore, a peak bin is detected at the same time as the peak in FIG. 7A. In this way, by changing the acquisition start time of the frequency distribution based on the peak time information of the frequency distribution acquired with the high resolution bins of the previous frame, the ranging accuracy can be improved.

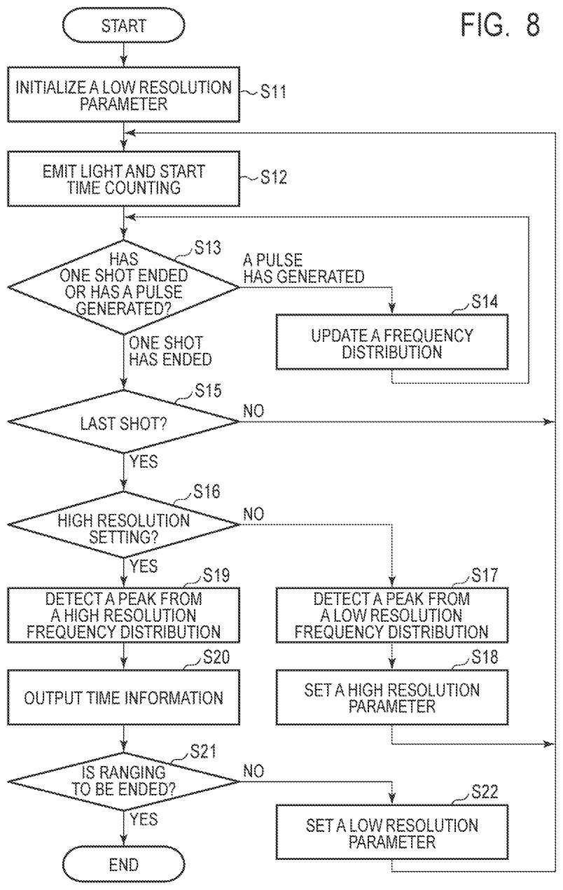

Next, a specific processing procedure for realizing the above-described processing and processing contents of each block will be described with reference to a flowchart of FIG. 8. FIG. 8 is a flowchart illustrating the operation of the ranging device 30 according to the present embodiment. FIG. 8 illustrates the operation from the start to the end of the ranging period.

In step S11 immediately after the start of the ranging, the control unit 31 outputs, as an initial setting, a control signal for setting the resolution to a low resolution to the decoder unit 35, the peak detection unit 37, and the parameter determination unit 38. The parameter determination unit 38 initializes a parameter so that the frequency distribution of the first frame period is acquired with low resolution bins.

A loop from step S12 to step S14 after the step S11 indicates a process in which signal acquisition of one shot is performed. A loop from the step S12 to step S15 indicates a process in which a frequency distribution of one frame is acquired.

In the step S12, the light emitting unit 32 emits light to the ranging area. At the same time, the time counting unit 34 starts time counting. Thereby, the signal acquisition processing of one shot is started. The control unit 31 controls the light emission of the light emitting unit 32 and the start of counting by the time counting unit 34 so as to be synchronized with each other. Thus, the elapsed time from the light emission can be counted.

In step S13, when the decoder unit 35 detects generation of a pulse caused by the incident light from the pulse signal output from the pulse generation unit 33 (“a pulse has generated” in the step S13), the process proceeds to the step S14. When the control unit 31 detects that the processing time of one shot has elapsed in the step S13 (“one shot has ended” in the step S13), the process proceeds to the step S15.

In the step S14, the decoder unit 35 updates the frequency distribution stored in the frequency distribution storage unit 36 based on a time count value at a timing when the pulse is detected and the parameter set by the parameter determination unit 38. The updating process may be a process of incrementing a pulse count value of a bin corresponding to the time count value at the timing at which the pulse is detected. After updating the frequency distribution, the process returns to the step S13. By the loop of the steps S13 and S14, pulse count values in each bin in one shot are sequentially acquired, and a frequency distribution is generated.

In the step S15, the control unit 31 determines whether or not the shot finished in the step S13 is the last shot, that is, whether or not signal acquisition of a predetermined number of shots is completed. When it is determined that the signal acquisition of the predetermined number of shots has not been completed (NO in the step S15), the process proceeds to the step S12, where the signal acquisition of the next shot is started, and the same process is repeated. When it is determined that the signal acquisition of the predetermined number of shots has completed (YES in the step S15), the process proceeds to step S16.

In the step S16, the control unit 31 determines whether or not the frequency distribution acquisition of the frame that has been processed in the immediately preceding step S15 is the high resolution setting. When it is determined that the setting is the high resolution setting (YES in the step S16), the process proceeds to step S19. When it is determined that the setting is not the high resolution setting, that is, when the setting is the low resolution setting (NO in the step S16), the process proceeds to step S17.

In the step S17, the peak detection unit 37 detects a peak from the low resolution frequency distribution (a first frequency distribution generated at a first time interval) of the frame that has been processed in the immediately preceding step S15. Then, in step S18, the control unit 31 outputs a control signal for setting the resolution to a high resolution to the decoder unit 35, the peak detection unit 37, and the parameter determination unit 38. The parameter determination unit 38 determines a parameter (second parameter) used for acquiring a frequency distribution of the next frame period based on the peak (first time information) detected from the low resolution frequency distribution. Here, the parameter determination unit 38 sets a parameter so that the frequency distribution of the next frame period is acquired with high resolution bins. Thereafter, the process proceeds to the step S12, and acquisition of the frequency distribution of the next frame is started.

In the step S19, the peak detection unit 37 detects a peak from the high resolution frequency distribution (a second frequency distribution generated at a second time interval) of the frame that has been processed in the immediately preceding step S15. Then, in step S20, the output unit 39 outputs peak time information corresponding to the peak to an external device of the ranging device 30 as a ranging result. Alternatively, the output unit 39 may output the distance information calculated from the peak time information and the light speed.

In step S21, the control unit 31 determines whether or not to end the ranging in the ranging device 30. When it is determined that the ranging is to be ended (YES in the step S21), the process ends. When it is determined that the ranging is not to be ended (NO in the step S21), the process proceeds to step S22. This determination may be based on, for example, a control signal or the like from a device on which the ranging device 30 is mounted.

In the step S22, the control unit 31 outputs a control signal for setting the resolution to the low resolution to the decoder unit 35, the peak detection unit 37, and the parameter determination unit 38. The parameter determination unit 38 determines a parameter (first parameter) used to acquire a frequency distribution of the next frame period based on the peak (second time information) detected from the frequency distribution of high resolution. Here, the parameter determination unit 38 sets a parameter so that the frequency distribution of the next frame period is acquired with the low resolution bins. Thereafter, the process proceeds to the step S12, and acquisition of the frequency distribution of the next frame is started.

As described above, by the processing from the step S16 to the step S22, an operation in which two kinds of high resolution bins and low resolution bins are alternately switched for each frame as illustrated in FIG. 5 is realized.

Next, the operation of the decoder unit 35 will be described in detail. The decoder unit 35 receives a signal indicating a start of a frame period from the control unit 31 and starts the operation. In addition, the decoder unit 35 receives a control signal indicating a resolution in acquiring the frequency distribution from the control unit 31, and receives a control signal indicating a start time and an end time of acquiring the frequency distribution from the parameter determination unit 38. The decoder unit 35 determines a memory address for updating the frequency distribution based on these control signals. The decoder unit 35 does not update the frequency distribution when the time count value indicating the time at which the pulse is received is before the start time of the frequency distribution acquisition or after the end time of the frequency distribution acquisition.

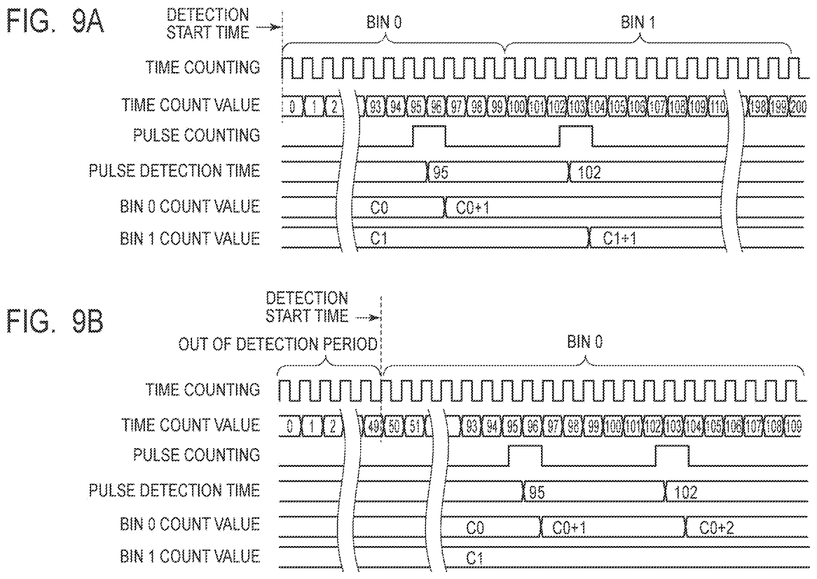

FIGS. 9A and 9B are timing charts illustrating the operation of the decoder unit 35 according to the present embodiment. The “time counting” and the “pulse counting” in FIGS. 9A and 9B are similar to those in FIG. 2. The “time count value” in FIGS. 9A and 9B indicates an elapsed time from the start of the frame period. Pulses illustrated in “pulse counting” indicate the timings of photon incidence. In FIGS. 9A and 9B, “pulse detection time”, “bin 0 count value”, and “bin 1 count value” indicate digital values related to the storage of the frequency distribution in the frequency distribution storage unit 36 and the update timings of the digital values. Here, “bin 0” is the first bin among the plurality of bins, and “bin 1” is the second bin among the plurality of bins. Between FIGS. 9A and 9B, the start times of frequency distribution acquisition (“detection start time” in FIGS. 9A and 9B) are different from each other.

The initial value of the time count value is “0”, and the time count value is incremented each time the decoder unit 35 detects the rising edge of the clock of the time counting. The “pulse count” indicates two pulses generated by photons entering the pulse generation unit 33. The decoder unit 35 latches a time count value at a timing at which a pulse corresponding to a photon rises and holds the time count value as a pulse detection time. The decoder unit 35 determines a memory address for updating the frequency distribution based on the held pulse detection time, and updates the value of the address.

FIG. 9A illustrates an example in which the time when the time count value is “0” is the start time of frequency distribution acquisition. In this example, when a photon is incident and a pulse rises in the pulse counting during a period in which the count value is “0” to “99”, the count value of “bin 0” is updated. When a photon is incident and a pulse rises in the pulse counting during a period in which the count value is “100” to “199”, the count value of “bin 1” is updated. The decoder unit 35 updates the value of “bin 0” from “C0” to “C0+1” in accordance with the pulse inputted at the time when the count value is “95”. Further, the decoder unit 35 updates the value of “bin 1” from “C1” to “C1+1” in accordance with the pulse inputted at the time when the count value is “102”.

FIG. 9B illustrates an example in which the time when the time count value is “50” is the start time of frequency distribution acquisition. In this example, when a photon is incident and a pulse rises in the pulse counting during a period in which the count value is “50” to “149”, the count value of “bin 0” is updated. When a photon is incident and a pulse rises in the pulse counting during a period in which the count value is “150” to “249”, the count value of “bin 1” is updated. The decoder unit 35 updates the value of “bin 0” from “C0” to “C0+1” in accordance with the pulse inputted at the time when the count value is “95”. Further, the decoder unit 35 updates the value of “bin 0” from “C0+1” to “C0+2” in accordance with the pulse inputted at the time when the count value is “102”. As described above, since a period in which the count value is “0” to “49” is a period before the detection start time, the period is out of the detection period.

Next, the operation of the peak detection unit 37 and the parameter determination unit 38 will be described in detail. The peak detection unit 37 receives a control signal indicating the completion of acquisition of the frequency distribution of one frame from the control unit 31, and starts the peak detection operation. In addition, the peak detection unit 37 receives a control signal indicating the acquisition resolution of the frequency distribution from the control unit 31, and when the control signal indicates the high resolution, the peak detection unit 37 transmits peak time information to the parameter determination unit 38 and the output unit 39. The peak detection unit 37 receives a control signal indicating the acquisition resolution of the frequency distribution from the control unit 31, and when the control signal indicates the low resolution, transmits peak time information only to the parameter determination unit 38.

In the above description, the peak time information generated by the peak detection unit 37 is information indicating a bin having the largest value in the frequency distribution, but the peak time information is not limited thereto. The peak time information may be information indicating a plurality of bins having a value larger than a predetermined value in the frequency distribution, or may be information indicating a plurality of bins including bins before and after the bin having the largest value. Further, different peak detection techniques may be applied to frequency distributions of different resolutions. Further, for the frequency distribution with high resolution, the peak detection unit 37 may calculate the peak time information to be transmitted to the parameter determination unit 38 and the peak time information to be transmitted to the output unit 39 using different peak detection methods.

The parameter determination unit 38 receives a control signal indicating the start timing of the frame period from the control unit 31 and starts the operation. In addition, the parameter determination unit 38 receives a control signal indicating the acquisition resolution of the frequency distribution from the control unit 31 and peak time information from the peak detection unit 37, determines the acquisition start time and the acquisition end time of the frequency distribution according to the resolution, and transmits them to the decoder unit 35.

As a preferred embodiment, the parameter determination unit 38 determines the acquisition start time and the acquisition end time of the frequency distribution of the high resolution bins of the next frame based on the peak time information in the frequency distribution acquired with the low resolution bins. Further, the parameter determination unit 38 determines the acquisition start time and the acquisition end time of the frequency distribution so that the time interval of the peak bin is positioned at the center of the low resolution bin of the next frame based on the peak time information in the frequency distribution acquired with the high resolution bins. However, the present embodiment is not limited thereto.

In the above embodiment, the decoder unit 35 controls the resolution of the frequency distribution (time interval of bins) by performing memory control based on the time count value. Further, an example in which the decoder unit 35 controls the start time and the end time of the time interval of the bins of the frequency distribution has been described. That is, an example in which the decoder unit 35 changes the first information on the time of the frequency distribution has been described. However, the present embodiment is not limited to this method. That is, the time counting unit 34 may change the first information of the frequency distribution.

For example, the resolution of the frequency distribution may be changed by operating the time counting unit 34 at different frequencies. Specifically, the time counting unit 34 is controlled to count time at a low frequency when forming a low resolution frequency distribution (coarse mode). On the other hand, when forming a high resolution frequency distribution, control is performed so as to count time at a high frequency (fine mode). Thereby, the width of the time interval per bin can be controlled, and the width of the time interval of the bins of the frequency distribution (resolution) can be changed. That is, the control of the time counting unit 34 may be switched by a control signal for setting the resolution received from the control unit 31 to change the first information of the frequency distribution.

The time counting unit 34 may also control the start time and the end time of the time interval of the bins. For example, the time counting unit 34 may control the operation or the stop of the operation for each time interval of the low resolution frequency distribution. The parameter determination unit 38 transmits, to the time counting unit 34, information indicating what number of bin in the low resolution frequency distribution is to be operated. The time counting unit 34 has a circuit that internally counts the number of elapsed low resolution frequency distributions. The time counting unit 34 compares the number of elapsed low resolution frequency distributions with information indicating what number of bin is to be operated, and starts the operation at the timing when they match. It is to be noted that a circuit for counting the number of elapsed low resolution frequency distributions can be realized with a simple configuration because the operating frequency can be set sufficiently low. That is, the control of the time counting unit 34 may be switched by the control signals indicating the start time and the end time of the frequency distribution acquisition received from the parameter determination unit 38 to change the first information of the frequency distribution.

As described above, in the present embodiment, the acquisition start time and the acquisition end time of the high resolution frequency distribution are determined based on the peak time information of the low resolution frequency distribution. Further, the acquisition start time and the acquisition end time of the low resolution frequency distribution are determined based on the peak time information of the high resolution frequency distribution. As a result, it is possible to reduce a necessary storage capacity, and to suppress a decrease in accuracy even in a case where a peak exists in the vicinity of a boundary of a low resolution bin. Accordingly, it is possible to provide a ranging device capable of achieving both reduction of storage capacity and high ranging accuracy.

### Second Embodiment

In the first embodiment, the configuration has been described in which the acquisition start time and the acquisition end time of the frequency distribution acquired with the low resolution bins are controlled based on the peak time information of the frequency distribution acquired with the high resolution bins. However, in the frequency distribution of the low resolution bins, control for making the resolution different for each bin may be performed. Hereinafter, a second embodiment will be described. Note that the configuration of the ranging device 30 illustrated in the present embodiment is an example, and is not limited to the illustrated configuration. In addition, description of elements common to those of the first embodiment may be omitted or simplified as appropriate.

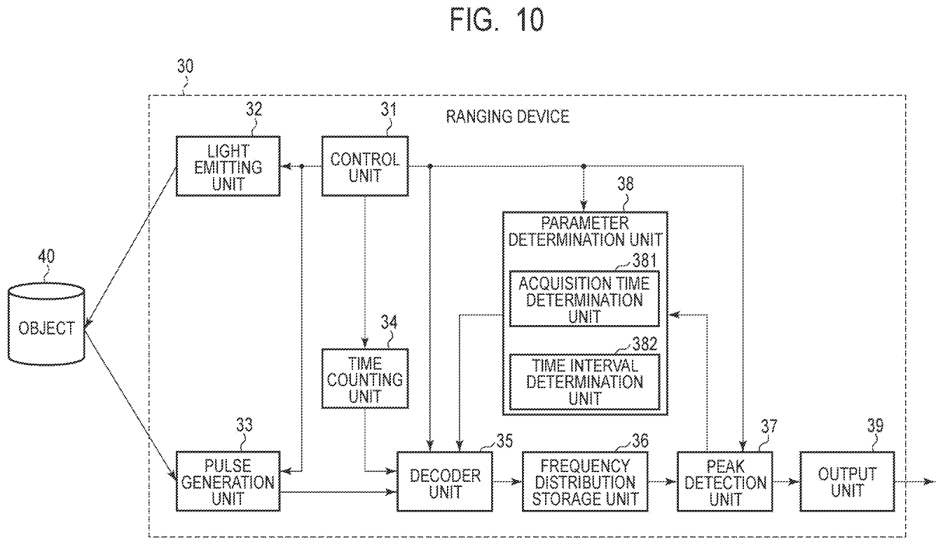

FIG. 10 is a block diagram illustrating a schematic configuration example of the ranging device 30 according to the present embodiment. The ranging device 30 includes a control unit 31, a light emitting unit 32, a pulse generation unit 33, a time counting unit 34, a decoder unit 35, a frequency distribution storage unit 36, a peak detection unit 37, a parameter determination unit 38, and an output unit 39. The parameter determination unit 38 includes an acquisition time determination unit 381 and a time interval determination unit 382. Since elements other than the decoder unit 35 and the parameter determination unit 38 perform substantially the same operation as in the first embodiment, the description thereof will be omitted or simplified.

The acquisition time determination unit 381 receives a control signal indicating the resolution in the acquisition of the frequency distribution from the control unit 31, and operates when the frequency distribution is to be acquired with the high resolution bins. The acquisition time determination unit 381 receives a control signal indicating the start timing of the frame period from the control unit 31 and starts the operation. The acquisition time determination unit 381 receives the peak time information in the frequency distribution by the low resolution bins from the peak detection unit 37, determines the acquisition start time and the acquisition end time of the frequency distribution to be acquired with the high resolution bins of the next frame, and notifies the decoder unit 35 of the determined acquisition start time and acquisition end time.

The time interval determination unit 382 receives a control signal indicating the resolution in the acquisition of the frequency distribution from the control unit 31, and operates when the frequency distribution is to be acquired with the low resolution bins. The time interval determination unit 382 receives a control signal indicating the start timing of the frame period from the control unit 31 and starts the operation. The time interval determination unit 382 receives the peak time information in the frequency distribution by the high resolution bins from the peak detection unit 37, determines the resolution for each time range of the frequency distribution to be acquired with the low resolution of the next frame, and notifies the decoder unit 35 of the resolution.

The decoder unit 35 performs memory control to update the value of the corresponding memory address of the frequency distribution storage unit 36 based on the pulse signal output from the pulse generation unit 33 and the time count value at the timing at which the pulse signal is transmitted. The decoder unit 35 receives a signal indicating the start of the frame period from the control unit 31 and starts the operation. Further, the decoder unit 35 receives a control signal indicating resolution in acquiring the frequency distribution from the control unit 31, and switches control contents in the case of acquiring the frequency distribution with the high resolution bins and in the case of acquiring the frequency distribution with the low resolution bins. When the frequency distribution is acquired with the high resolution bins, the decoder unit 35 determines a memory address for updating the frequency distribution based on the information of the acquisition start time and the acquisition end time of the frequency distribution from the acquisition time determination unit 381. When the frequency distribution is acquired with the low resolution bins, the decoder unit 35 determines a memory address for updating the frequency distribution based on the time interval information from the time interval determination unit 382.

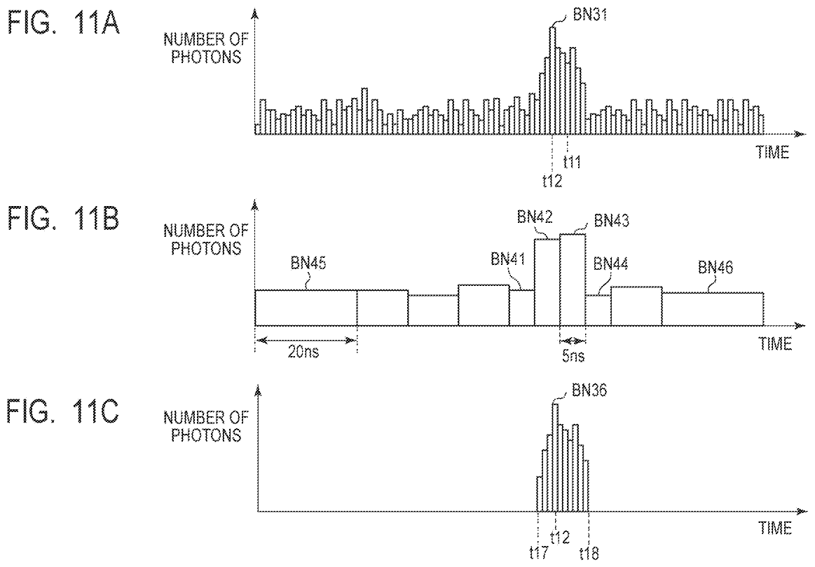

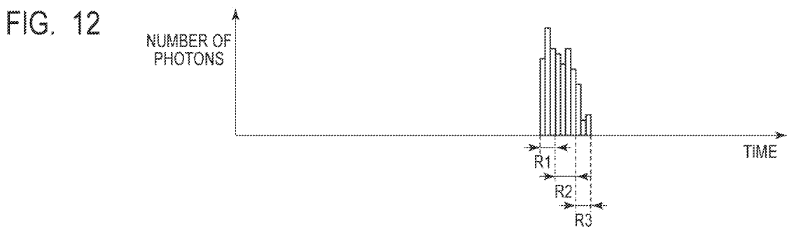

FIGS. 11A to 11C are histograms for explaining an example of changing the length of the time interval of the frequency distribution according to the second embodiment. The operation of the time interval determination unit 382 will be described in detail with reference to FIGS. 11A to 11C. FIG. 11A is similar to FIG. 7A, and a description thereof will be omitted.

FIG. 11B illustrates an example of a histogram when the resolution of a bin is changed for each time range in acquiring a frequency distribution with the low resolution bins. The time interval determination unit 382 determines a bin whose time interval is set narrow among the low resolution bins of the next frame based on the time information of the peak of the frequency distribution of the high resolution bins of the previous frame. In the example of FIG. 11B, the time intervals of bins BN41, BN42, BN43, and BN44 set to be narrow are set to a length that is ½ of the normal time interval (5 ns).

FIG. 12 is a histogram for explaining a bin determination method for changing the length of the time interval according to the second embodiment. The time interval determination unit 382 determines a bin having narrow time interval of the histogram according to which of the three ranges R1, R2, and R3 illustrated in FIG. 12 includes the peak in the high resolution frequency distribution. When a peak is included in the range R1 as illustrated in FIG. 12, the time intervals of two bins including a bin including the peak and a bin earlier in time than the bin including the peak are narrowed. When a peak is included in the range R2, the time interval is not changed. When a peak is included in the range R3, the time intervals of two bins including a bin including the peak and a bin which is later in time than the bin including the peak are narrowed. Thus, when a peak exists near the boundary of the low resolution bin, the range of the frequency distribution acquired with the high resolution bins of the next frame can be appropriately set.

It is to be noted that the determination method of the bin for changing the length of the time interval applicable to the present embodiment is not limited to this, and for example, in order to accurately detect an object approaching the ranging device 30, a bin including a peak and a bin earlier in time than the bin including the peak may be set with higher priority.

FIG. 11B illustrates an example in which the time intervals of bins BN41, BN42, BN43, and BN44 in the low resolution frequency distribution are narrowed, and two bins BN42 and BN43 are detected as peaks by the above-described method. In this example, since the time intervals of a part of the low resolution bins are set to ½, even if two of the bins of this resolution are selected, the storage capacity necessary for storing the high resolution bins does not change.

FIG. 11C illustrates an example of a histogram of a frequency distribution acquired with the high resolution bins. The bin BN36 at the time t12 can be detected as a peak by generating a frequency distribution with high resolution bins for the bin BN42 and the bin BN43.

Incidentally, in the low resolution frequency distribution, the required memory capacity is increased by narrowing the time interval of bins. Therefore, the time interval determination unit 382 may have a function of making the total amount of necessary storage capacity constant by widening the time intervals of bins away from the peak. In FIG. 11B, by setting the time intervals of bins BN45 and BN46 to twice the length (20 ns), the total amount of necessary storage capacity is kept constant.

As described above, according to the present embodiment, different resolutions can be determined for bins of the low resolution frequency distribution based on the peak time information of the high resolution frequency distribution. As a result, it is possible to reduce a necessary storage capacity, and to suppress a decrease in accuracy even in a case where a peak exists in the vicinity of a boundary of a low resolution bin. Accordingly, it is possible to provide a ranging device capable of achieving both reduction of storage capacity and high ranging accuracy.

### Third Embodiment

In the present embodiment, a specific configuration example of a photoelectric conversion device that includes an avalanche photodiode and that can be applied to the ranging device 30 according to the first or second embodiment will be described. The configuration example of the present embodiment is an example, and the photoelectric conversion device applicable to the ranging device 30 is not limited thereto.

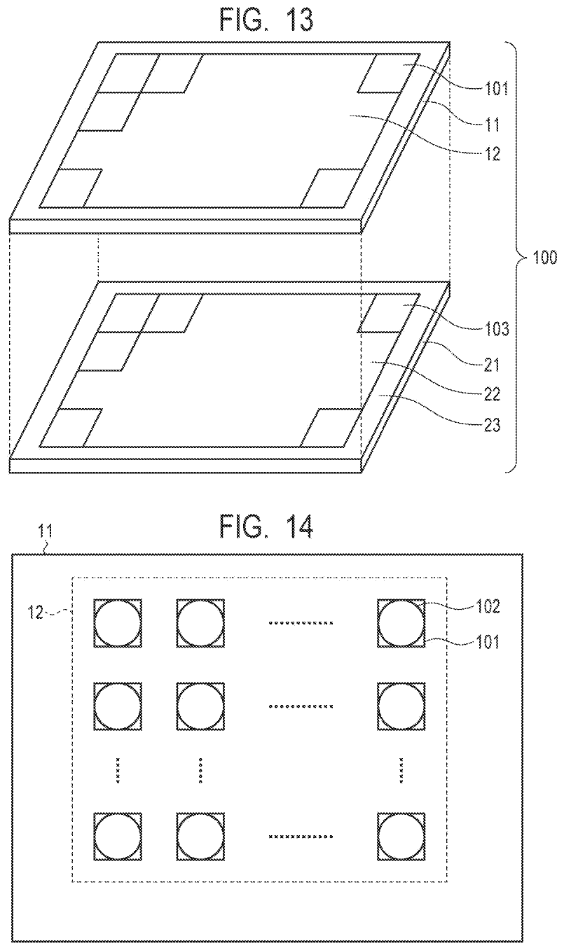

FIG. 13 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

FIG. 14 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

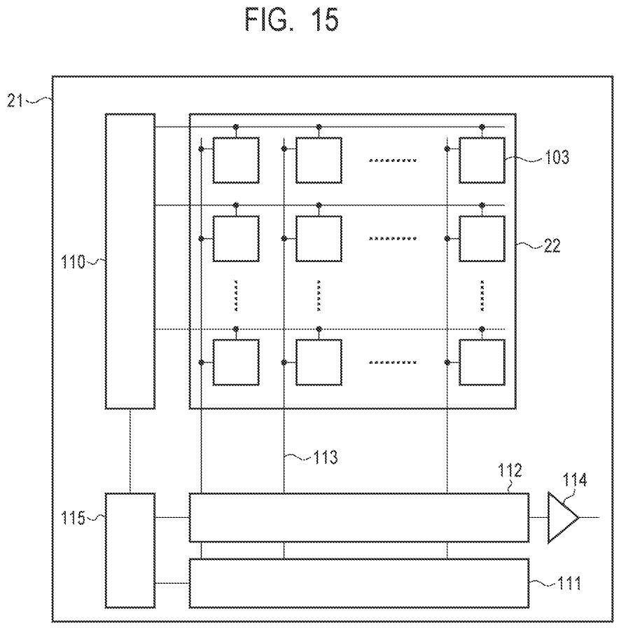

FIG. 15 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 14 and the plurality of pixel signal processing units 103 illustrated in FIG. 15 are electrically connected to each other via connection wirings provided for each pixels 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixels 101 is processed by the pixel signal processing unit 103. The pixel signal processing unit 103 acquires and holds a digital signal having a plurality of bits by counting the number of pulses output from the APD included in the photoelectric conversion unit 102.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 14 and 15, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 15. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

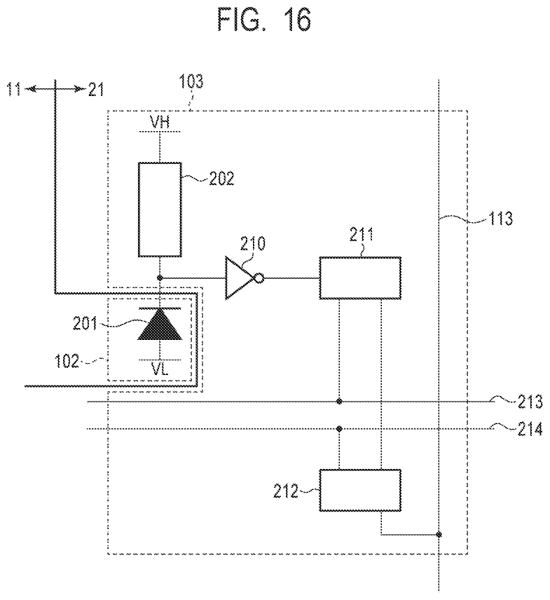

FIG. 16 is a schematic block diagram illustrating a configuration example of one pixel of the photoelectric conversion unit 102 and the pixel signal processing unit 103 according to the present embodiment. FIG. 16 schematically illustrates a more specific configuration example including a connection relationship between the photoelectric conversion unit 102 arranged in the sensor substrate 11 and the pixel signal processing unit 103 arranged in the circuit substrate 21. In FIG. 16, driving lines between the vertical scanning circuit 110 and the pixel signal processing unit 103 in FIG. 15 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates charge pairs corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 16 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulse signals output from the waveform shaping unit 210, and holds a digital signal indicating the count value. When a control signal is supplied from the vertical scanning circuit 110 through the driving line 213, the counter circuit 211 resets the held signal.

The selection circuit 212 is supplied with a control signal from the vertical scanning circuit 110 illustrated in FIG. 15 through the driving line 214 illustrated in FIG. 16. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 16, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

FIG. 16 illustrates a configuration example using the counter circuit 211. However, instead of the counter circuit 211, a time-to-digital converter (TDC) and a memory may be used to acquire a timing at which a pulse is detected. In this case, the generation timing of the pulsed signal output from the waveform shaping unit 210 is converted into a digital signal by the TDC. In this case, a control signal (reference signal) can be supplied from the vertical scanning circuit 110 illustrated in FIG. 15 to the TDC via the driving line. The TDC acquires, as a digital signal, a signal indicating a relative time of input timing of a pulse with respect to the control signal.

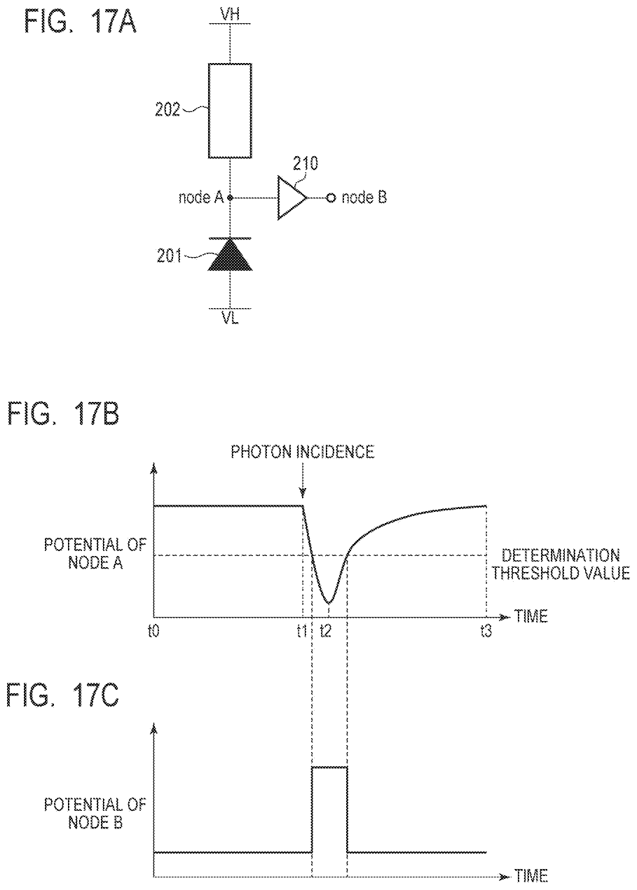

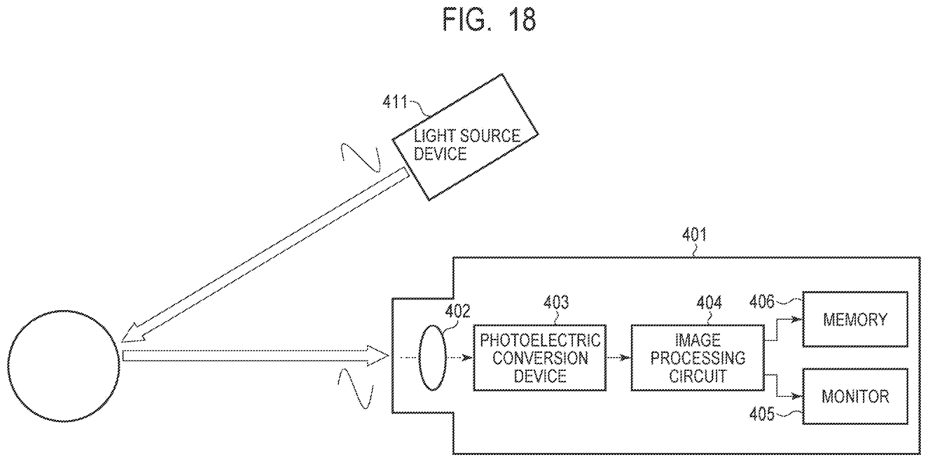

FIGS. 17A to 17C are diagrams illustrating an operation of the APD 201 according to the present embodiment. FIG. 17A is a diagram illustrating the APD 201, the quenching element 202, and the waveform shaping unit 210 in FIG. 16. As illustrated in FIG. 17A, the connection node of the APD 201, the quenching element 202, and the input terminal of the waveform shaping unit 210 is referred to as node A. Further, as illustrated in FIG. 17A, an output side of the waveform shaping unit 210 is referred to as node B.

FIG. 17B is a graph illustrating a temporal change in the potential of node A in FIG. 17A. FIG. 17C is a graph illustrating a temporal change in the potential of node B in FIG. 17A. During a period from time t0 to time t1, the voltage VH-VL is applied to the APD 201 in FIG. 17A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

The pulse generation unit 33 in the first or second embodiment corresponds to, for example, the APD 201, the quenching element 202, and the waveform shaping unit 210 of the present embodiment. The control unit 31 in the first or second embodiment corresponds to, for example, the control signal generation unit 115, the vertical scanning circuit 110, and the horizontal scanning circuit 111 of the present embodiment.

According to the present embodiment, a photoelectric conversion device using an avalanche photodiode which can be applied to the ranging device 30 of the first or second embodiment is provided.

### Fourth Embodiment

FIG. 18 is a block diagram of a photodetection system according to the present embodiment. More specifically, FIG. 18 is a block diagram of a distance image sensor and a light source device as an example of the ranging device 30 described in the above embodiment.

As illustrated in FIG. 18, the distance image sensor 401 includes an optical system 402, a photoelectric conversion device 403, an image processing circuit 404, a monitor 405, and a memory 406. The distance image sensor 401 receives light (modulated light or pulsed light) emitted from a light source device 411 toward an object and reflected by the surface of the object. The distance image sensor 401 can acquire a distance image corresponding to a distance to the object based on a time period from light emission to light reception. The light source device corresponds to the light emitting unit 32 of the above embodiments, and the photoelectric conversion device 403 corresponds to other blocks in the ranging device 30.

The optical system 402 includes one or a plurality of lenses, and guides image light (incident light) from the object to the photoelectric conversion device 403 to form an image on a light receiving surface (sensor portion) of the photoelectric conversion device 403.

The photoelectric conversion device 403 supplies a distance signal indicating a distance obtained from the received light signal to the image processing circuit 404. The image processing circuit 404 performs image processing for forming a distance image based on the distance signal supplied from the photoelectric conversion device 403. The distance image (image data) obtained by the image processing can be displayed on the monitor 405 and stored (recorded) in the memory 406.

The distance image sensor 401 configured in this manner can acquire an accurate distance image by applying the configuration of the above-described embodiments.

### Fifth Embodiment

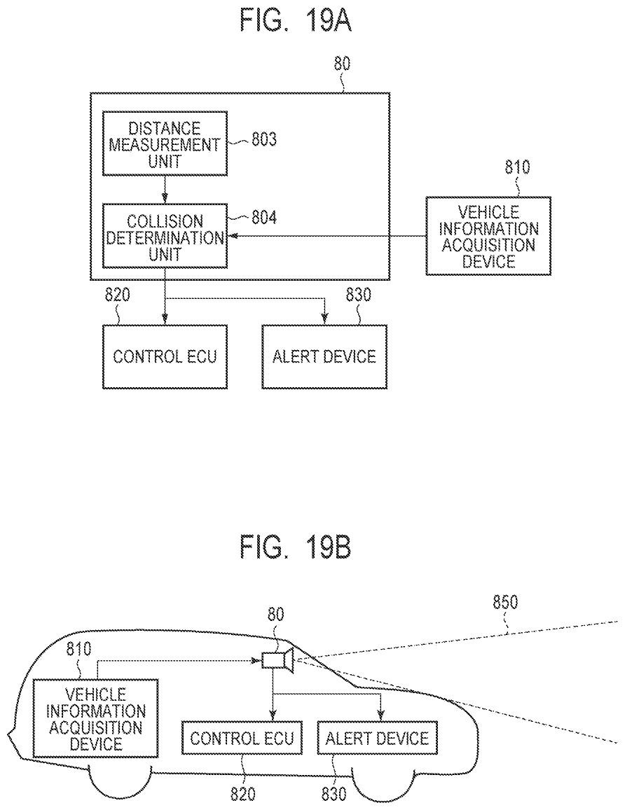

FIGS. 19A and 19B are block diagrams of equipment relating to an in-vehicle ranging device according to the present embodiment. Equipment 80 includes a distance measurement unit 803, which is an example of the ranging device of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 19B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiment, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-112271, filed Jul. 13, 2022, which is hereby incorporated by reference herein in its entirety.

What is claimed is:

1. A ranging device comprising:
a time counting unit configured to perform time counting;
a pulse generation unit configured to generate a signal including a pulse based on light including reflected light from an object;
a frequency distribution storage unit configured to store a frequency distribution including first information on time and second information on the number of pulses;
a peak detection unit configured to determine time information indicating a time corresponding to a peak of the number of pulses based on the frequency distribution;
a parameter determination unit configured to determine, based on the time information, a parameter used for acquiring a frequency distribution in a frame period next to a frame period in which the time information is acquired; and
a decoder unit configured to change the second information of the frequency distribution stored in the frequency distribution storage unit,
wherein in accordance with the parameter, the time counting unit or the decoder unit is configured to change the first information of the frequency distribution,
wherein the decoder unit selectively generates, for each frame period, either a first frequency distribution generated at a first time interval or a second frequency distribution generated at a second time interval shorter than the first time interval,
wherein the parameter determination unit determines a second parameter used for acquiring the second frequency distribution based on first time information indicating a time corresponding to a peak of the number of pulses in the first frequency distribution, and
wherein the parameter determination unit determines a first parameter used for acquiring the first frequency distribution based on second time information indicating a time corresponding to a peak of the number of pulses in the second frequency distribution.

2. The ranging device according to claim 1 further comprising:
a light emitting unit configured to emit light to the object; and
a control unit configured to synchronously control a timing at which the light emitting unit emits light and a timing at which the time counting unit starts time counting.

3. The ranging device according to claim 1, wherein the second parameter includes information indicating a start time and an end time of acquisition of the second frequency distribution.

4. The ranging device according to claim 3, wherein the parameter determination unit determines the start time and the end time of acquisition of the second frequency distribution so that the second frequency distribution includes the peak of the number of pulses in the first frequency distribution.

5. The ranging device according to claim 1, wherein the first parameter includes information indicating a start time and an end time of acquisition of the first frequency distribution.

6. The ranging device according to claim 5, wherein the parameter determination unit determines the start time and the end time of acquisition of the first frequency distribution so that the peak of the number of pulses in the second frequency distribution is separated from a boundary of the first time interval.

7. The ranging device according to claim 1, wherein the first parameter includes information indicating a length of the first time interval in a part of the first frequency distribution.

8. The ranging device according to claim 7, wherein the parameter determination unit determines the length of the first time interval so that the first time interval in a part of the first frequency distribution corresponding to the peak of the number of pulses in the second frequency distribution is shorter than that in another part of the first frequency distribution.

9. The ranging device according to claim 1, wherein the decoder unit alternately generates the first frequency distribution and the second frequency distribution for each frame period.

10. The ranging device according to claim 1 further comprising an output unit configured to output the second time information as a ranging result.

11. A ranging device comprising:
a time counting unit configured to perform time counting;
a pulse generation unit configured to generate a signal including a pulse based on light including reflected light from an object;
a frequency distribution storage unit configured to store a frequency distribution including first information on time and second information on the number of pulses;
a peak detection unit configured to determine time information indicating a time corresponding to a peak of the number of pulses based on the frequency distribution;
a parameter determination unit configured to determine, based on the time information, a parameter used for acquiring a frequency distribution in a frame period next to a frame period in which the time information is acquired; and
a decoder unit configured to change the second information of the frequency distribution stored in the frequency distribution storage unit,
wherein in accordance with the parameter, the time counting unit or the decoder unit is configured to change the first information of the frequency distribution,
wherein the decoder unit selectively generates, for each frame period, any one of three or more frequency distributions having different time intervals, and
wherein the parameter determination unit determines a parameter used for acquiring a frequency distribution generated at the longest time interval among the three or more frequency distributions based on time information indicating a time corresponding to a peak of the number of pulses in a frequency distribution generated at the shortest time interval among the three or more frequency distributions.

12. The ranging device according to claim 11 further comprising:
a light emitting unit configured to emit light to the object; and
a control unit configured to synchronously control a timing at which the light emitting unit emits light and a timing at which the time counting unit starts time counting.

13. The ranging device according to claim 11, wherein the parameter includes information indicating a start time and an end time of acquisition of the frequency distribution.

14. The ranging device according to claim 11, wherein the parameter includes information indicating a length of the time interval in a part of the frequency distribution.

15. A photodetection system comprising:
the ranging device according to claim 1; and
a signal processing unit configured to process a signal output from the ranging device.

16. A movable body comprising:
the ranging device according to claim 1; and
a movable body control unit configured to control the movable body based on distance information acquired by the ranging device.
